(19) United States
(12) Patent Application Publication
(10) Pub. No.: US 2013/0313072 A1
(43) Pub. Date: Nov. 28, 2013

(54) TRANSPORT DEVICE WITH IDENTIFICATION FUNCTION

(71) Applicants: Heinrich van de Loecht, Muggensturm (DE); Martin Reinisch, Esslingen (DE)

(72) Inventors: Heinrich van de Loecht, Muggensturm (DE); Martin Reinisch, Esslingen (DE)

(73) Assignee: ROBERT BOSCH GMBH, Stuttgart (DE)

(21) Appl. No.: 13/984,280

(22) PCT Filed: Feb. 7, 2012
(86) PCT No.: PCT/EP2012/052019

§ 371 Date: Aug. 7, 2013

(30) Foreign Application Priority Data
Feb. 7, 2011 (DE) 102011003682.2

(51) Int. Cl. B65G 43/08

(52) U.S. Cl. CPC B65G 43/08
USPC 198/464.1

(57) ABSTRACT

The present invention relates to a transport device for transporting products, in particular for feeding packaging machines, comprising a transfer section (2), an electromagnetic drive with a multiplicity of coil elements (3) and a multiplicity of permanent magnets (4), wherein the coil elements (3) are arranged in a stationary manner on the transfer section (2), a multiplicity of rotors (5) which are arranged movably on the transfer section (2), wherein at least in each case one permanent magnet (4) of the electromagnetic drive is arranged on a rotor (5), at least one sensor (7) which is arranged in a stationary manner on the transfer section (2), and individual marking devices (8) which can be detected by means of the sensor and which are in each case different from one another, wherein in each case at least one of the marking devices (8) is arranged on a rotor (5).

### BACKGROUND OF THE INVENTION

The present invention relates to a transport device for transporting products, in particular for feeding packaging machines, a detection and tracking of rotors being possible with said transport device.

A revolving transport device, which has an improved drive concept, is known from the German patent specification DE 102009002606 A1. Said known transport device comprises a circulating transport path, at least one rotor and an electromagnetic drive having a plurality of stationary coil elements and a permanent magnet arranged on the rotor. If a relatively long transport path is present with such transport devices, on which a multiplicity of rotors is moved, a monitoring of the rotors can be difficult. In order to control the electromagnetic drive, it is however necessary to know where the respective rotor is located. A tracking of a rotor and thus the product transported by the same is also desirable over the entire transport path. Such a system should, however, be as simple and reliable as possible.

### SUMMARY OF THE INVENTION

The inventive transport device has the advantage over the prior art that a simple and cost-effective identification of rotors on a transfer section is possible. In particular, purely passive elements without an energy supply can be used on the rotors to identify the same. In so doing, the inventive identification device is not susceptible to contamination and can even be used at higher speeds which are greater than 4 m/s. In addition, the inventive identification device is free of wear. This is achieved according to the invention by virtue of the fact that the identification device comprises at least one sensor arranged in a stationary manner on the transfer section and one individual marking device which can be detected by means of the sensor. The marking device is arranged in each case on a rotor and is individually configured. All of the rotors can thus be unambiguously identified at any time on the transfer section, whereby a tracking of the transported product is also possible.

A multiplicity of sensors is preferably disposed along the transfer section. In a particularly preferred manner, the sensors are in each case evenly spaced apart from one another. In so doing, the rotor can be identified multiple times. By means of the large number of data collected, a very accurate positioning of the rotor is possible.

According to a preferred embodiment, each rotor has at least two different individual marking devices. As a result, redundancy can be provided for a reliable detection of said rotor.

In a further preferred manner, the transport device comprises a position detection device for detecting a position of the rotor on the transfer section. In a particularly preferred manner, the position detection device is connected to the inventive identification device; and therefore the system cannot only detect the positions at which rotors are located but can also exactly determine at what position each rotor is located, in particular if the rotors are situated between two sensors.

According to a preferred exemplary embodiment of the invention, the identification device comprises an RFID sensor as the sensor and the marking device is an RFID element. In so doing, a particularly cost-effective identification device can be provided.

The marking device is preferably designed such that additional further optional data can be stored and/or amended and/or deleted and/or read out.

According to an alternative embodiment of the invention, the sensor of the identification device is a Hall sensor and the individual marking device is a permanent magnet. Said inventive identification device can likewise be provided very simply and cost-effectively.

According to a still further preferred alternative of the invention, the sensor of the identification device is an incremental encoder and the individual marking device comprises a plurality of magnetic strips of permanent magnets.

In the case of identification devices, which use permanent magnets as marking devices, it should be noted that the permanent magnets preferably have different magnetic strengths and/or different polarities as distinguishing features. As a result, an individual identification of each rotor can be facilitated in each case.

In a particularly preferred manner, a signal of the incremental encoder is also supplied to the position detection device. Because an identification device comprising an incremental encoder and magnetic strip also represents a very accurate displacement measuring system having an accuracy up to 10 μm, this information can also be selectively used to determine the exact position of the rotor. As a result, an already present position detection system can, for example, be made even more exact.

According to a further preferred embodiment of the invention, the inventive identification device comprises a barcode reader and a bar code element as the individual marking device. Such an identification device can also be provided very simply and cost-effectively.

The invention is preferably used on circumferentially closed transfer sections. The routing of the transfer sections can thereby take on any desired design, i.e. can comprise straight and curved sections in any desired arrangement. In a particularly preferred manner, the transport device of the invention is used in combination with a feeding of packaging machines.

### BRIEF DESCRIPTION OF THE DRAWINGS

An exemplary embodiment of the invention is described below in detail with reference to the accompanying drawing. In the drawing:

FIG. 1 shows a schematic depiction of a transport device according to a preferred exemplary embodiment of the invention.

### DETAILED DESCRIPTION

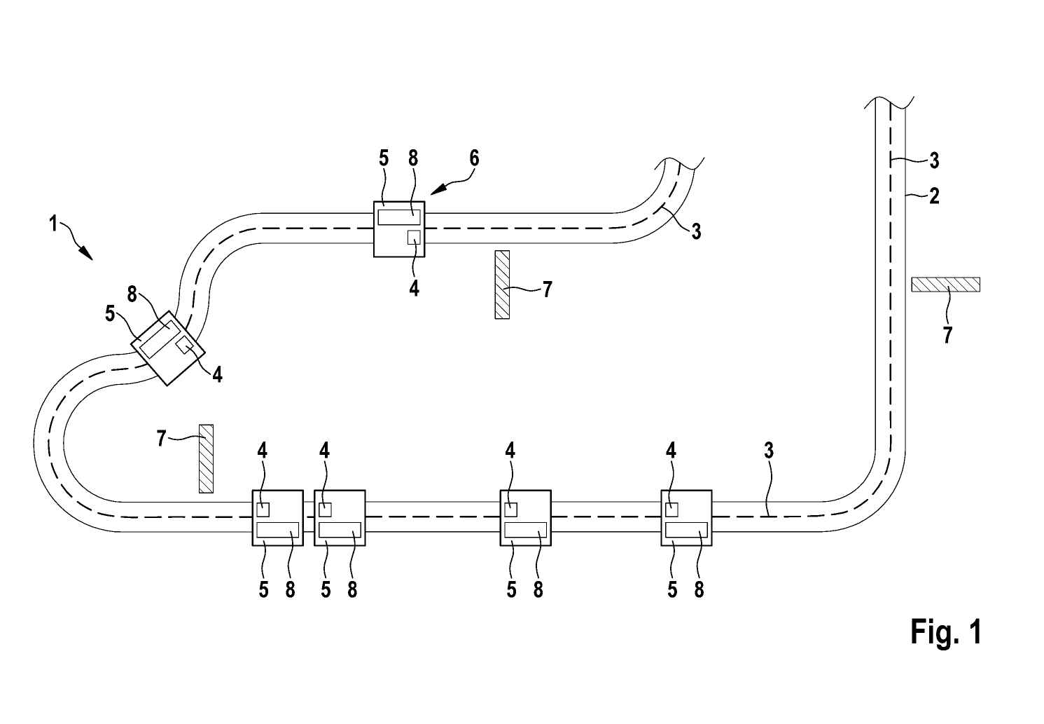

As can be seen from FIG. 1, the transport device 1 comprises a transfer section 2 and an electromagnetic drive. The electromagnetic drive comprises a multiplicity of stationary coil elements 3, which are arranged on the transfer section 2, and a multiplicity of permanent magnets 4, respectively one permanent magnet 4 being arranged on a rotor 5. The individual coil elements 3 can thereby be respectively actuated and supplied with current individually from one another in order to move the rotors along the transfer section 2. The transfer section 2 can thereby be linear or circumferentially closed.

The transport device 1 further comprises an individual identification device 6 which comprises a multiplicity of stationary sensors 7 and a multiplicity of individual marking devices 8. In so doing, the identification device 6 can comprise different sensors 7 and marking devices 8, for example RFID sensors and RFID elements, Hall sensors and permanent magnets, incremental encoders and magnetic strips, or barcode sensors and barcode elements. It is common to all of the inventive sensors and marking devices that a hardware based solution of the identification is implemented. In this connection, purely passive elements are used on the rotors 5, which elements do not require a supply of energy; thus enabling the rotors to be simply and cost-effectively designed.

Particularly when using RFID sensors and RFID elements besides the individual marking being detected the RFID elements on the rotors 5 cannot only be read out but actively described when moving past said RFID sensors. A storage of a further feature on the RFID element is also possible. For example, not only the rotor identification on the RFID element could be present on the RFID element but also a further datum which, for example is stored for the production thereof on the RFID element and can be read out at another location and/or amended.

It is also possible according to the invention, for example, to detect faulty rotors 5 and to preventively replace the same prior to a possibly occurring malfunction. To this end, the rotors 5 are all moved with an exactly same movement profile across a defined measuring section. A specific profile for supplying current to the electromagnetic drive is deposited in the control unit, said profile, for example, being ascertained and stored during an initial operation. By continuously comparing the deposited profile with the currently measured current values in defined time intervals, conclusions can be drawn as to whether a rotor 5 has an increased current demand. This can, for example, point to a mechanical problem, e.g. a worn rotor guide. According to the invention, the affected rotor 5 can now be unambiguously determined and if need be replaced.

A possibly necessary reference run of the rotors 5 in combination with a position detection system, which detects positions of the rotors on the transfer section 2, can, for example, also be shortened after completely switching off the transport device. If, for example, after switching on the transport device again, the position detection device still reports the same positions of the rotors 5 as before being switched off, it can be assumed that the rotors were not moved manually in the meantime. According to the invention, this can now be additionally verified by a shorter reference run be executed, namely until a rotor 5 is detected by one of the sensors 7 and unambiguously identified. If the detected identification of the rotor 5 now still correlates with the identification at this position which was stored before switching off the system, the reference run can be concluded and clear conditions prevail in the transport device. If, however, the detected identification does not correlate with the identification stored before switching off the system, this means that one or a plurality of rotors 5 was moved by hand during the switched-off state. In this case, a longer reference run is required until all rotors have been unambiguously identified.

1. A transport device for transporting products, comprising:
a transfer section (2),
an electromagnetic drive with a multiplicity of coil elements (3) and a multiplicity of permanent magnets (4), wherein the coil elements (3) are arranged in a stationary manner on the transfer section (2),
a multiplicity of rotors (5) which are arranged movably on the transfer section (2), wherein at least in each case one permanent magnet (4) of the electromagnetic drive is arranged on the rotor (5),
at least one sensor (7) which is arranged in a stationary manner on the transfer section (2), and
individual marking devices (8) which can be detected by means of the sensor and which are in each case different from one another,
wherein in each case at least one of the marking devices (8) is arranged on a rotor (5).

2. The transport device according to claim 1, characterized in that the transport device comprises a multiplicity of sensors (7).

3. The transport device according to claim 1, characterized in that each rotor (5) comprises at least two different, individual marking devices (8).

4. The transport device according to claim 1, further comprising a position detection device in order to detect a position of the rotors (5) on the transfer section (2).

5. The transport device according to claim 1, characterized in that the individual marking device (8) is designed such that additional data can be at least one of the following: stored; amended; deleted and read out.

6. The transport device according to claim 1, characterized in that the sensor (7) is an RFID sensor and the marking device (8) is an RFID element.

7. The transport device according to claim 1, characterized in that the sensor is a Hall sensor and the marking device (8) is a permanent magnet.

8. The transport device according to claim 1, characterized in that the sensor (7) is an incremental encoder and the marking device (8) comprises strip-like permanent magnets.

9. The transport device according to claim 7, characterized in that the permanent magnets have at least one of different magnetic strengths and different polarities.

10. The transport device according to claim 1, characterized in that the sensor (7) is a barcode reader and the marking device (8) is a barcode element.

11. The transport device according to claim 1, characterized in that the individual marking device (8) is designed such that items of information can be at least one of the following: stored; amended; deleted and read out.

12. The transport device according to claim 11, characterized in that the individual marking device (8) is designed such that additional data can be at least one of the following:
stored; amended; deleted and read out.

13. The transport device according to claim 1, characterized in that the sensor (7) is a barcode reader and the marking device (8) is an imprint.

14. The transport device according to claim 1, characterized in that the sensor (7) is a barcode reader and the marking device (8) is an adhesive label.
